(19) United States
(12) Patent Application Publication
(10) Pub. No.: US 2008/0042964 A1
(43) Pub. Date: Feb. 21, 2008

(54) Simple-matrix liquid crystal driving method, liquid crystal driver, and liquid crystal display apparatus

(75) Inventors: Norimitsu Sako, Chiba (JP); Hideyuki Kitayama, Chiba (JP)

Correspondence Address: OLIFF & BERRIDGE, PLC, P.O. BOX 320850, ALEXANDRIA, VA, 22320-4850, US

(73) Assignee: KAWASAKI MICROELECTRONICS, INC., CHIBA-SHI (JP)

(21) Appl. No.: 11/819,668

(22) Filed: Jun. 28, 2007

(30) Foreign Application Priority Data
Jun. 30, 2006 (JP) 2006-181688

(51) Int. Cl. G09G 3/36

(52) U.S. Cl. 345/98

(57) ABSTRACT

A cyclic orthogonal matrix with three rows and four columns is used to drive a simple-matrix liquid crystal panel. Three gradation palettes having different phases of ON/OFF data of intermediate gradations are generated. A frame-rate-control phase table for an entire screen of the liquid crystal panel is generated in which the three gradation palettes are distributed so that the sequence direction of the ON/OFF data of the three gradation palettes coincides with the circulation direction of data of the cyclic orthogonal matrix, and a predetermined gradation palette is assigned to each pixel of the liquid crystal panel. Frames of the frame-rate-control gradation system and column vectors of the cyclic orthogonal matrix are simultaneously updated field-by-field to perform drive control and gradation control of each pixel of the liquid crystal panel. The gradation display of each pixel of the liquid crystal panel is completed for 12 fields constituting the three frames of the frame-rate-control gradation system.

Exemplary embodiments of this invention were first described in Japanese Application No. 2006-181688, which was filed on Jun. 30, 2006 and is hereby incorporated by reference in its entirety.

### BACKGROUND

Exemplary embodiments of this invention relate to a method for driving a simple-matrix liquid crystal panel (or simple-matrix liquid crystal) in which drive control is performed using a multi-line addressing (MLA) drive system and gradation control is performed using a frame rate control (FRC) gradation system, a liquid crystal driver for performing drive control and gradation control of the simple-matrix liquid crystal using the driving method, and a liquid crystal display apparatus (LCD).

One known drive system for LCDs using simple-matrix liquid crystal is an MLA drive system for simultaneously selecting a plurality of row electrodes (e.g., via common electrodes) in rows using an orthogonal matrix. In the MLA drive system, when L rows are simultaneously selected, an MLA calculation is performed using an orthogonal matrix with L rows and M columns, and the driving of row electrodes and column electrodes (i.e., segment electrodes) is controlled accordingly.

In the MLA drive system, an image displayed on a screen is formed from a plurality of frames (e.g., display cycles). One frame represents a time period required to display (or construct) an ON/OFF state of one image, and includes M fields, which is the same number as the number of column vectors of the orthogonal matrix. One field represents a time period required to select all the row electrodes of the liquid crystal panel once from the top to the bottom.

A total number of N row electrodes of the liquid crystal panel are divided into C (where C=N/L) common blocks each including L row electrodes to be simultaneously selected. In the MLA calculation, L row electrodes in each of the common blocks are simultaneously selected by applying predetermined row-electrode voltages, and column-electrode voltages that correspond to display data are applied to the column electrodes to control the on/off operation of pixels (e.g., picture elements) located at intersections of the row electrodes and the column electrodes.

More specifically, the L row electrodes to be simultaneously selected in each of the common blocks are selected on a field-by-field basis by a corresponding column vector (or selection pattern) of the orthogonal matrix. The L row electrodes to be simultaneously selected are supplied with, for example, a ground voltage during a non-selection period, and are supplied with row-electrode voltages +Vr and −Vr according to “1” and “−1” of the bits of the column vectors of the orthogonal matrix, respectively, during a selection period.

Each of the column electrodes is generally applied with a column-electrode voltage corresponding to display data from among (L+1) column-electrode voltages having different voltage levels. Specifically, a sum of exclusive ORs of bits of a column vector of the orthogonal matrix used to determine a row-electrode voltage and bits of the corresponding display data is calculated. The column-electrode voltage corresponding to the sum is applied to the corresponding column electrode.

The above-described operation is sequentially performed on the C common blocks included in one field. The i-th (where i=1 to M) column vector of the orthogonal matrix is sequentially assigned to the i-th field of one frame as a selection pattern, and each of the common blocks is controlled so that all the column vectors are used once within one frame. The above operation is repeatedly performed to sequentially refresh the display screen.

In LCDs, an FRC gradation system is used as a control system for gradation display. In the FRC gradation system, one displayed image is represented in gradations using a plurality of frames. More specifically, the ON/OFF state of each pixel is determined for each of the frames, and the number of times each pixel is turned on/off is controlled using the plurality of frames to represent the gradations of the displayed image.

In the FRC gradation system, if the number of gradations is denoted by K, the gradation representation of one screen is completed within (K−1) frames. In LCDs using the MLA drive system, therefore, a time period as long as (K−1)×M fields is required until the display of one screen has been completed. If the frame frequency of the image being displayed is low, the switching of the pixels displaying intermediate gradations between the ON and OFF states appears as flicker. If the frame frequency is increased, the occurrence of flicker is reduced although noticeable crosstalk is induced and power consumption is increased.

As a countermeasure to the above problem, for example, Japanese Patent No. 3582919 proposes that spatial modulation is performed using a threshold table that is a vector having a number of elements equal to the number of frames used in the FRC gradation system and a phase table having elements each corresponding to a pixel in a pixel block to which the spatial modulation is applied, and the proportion of columns for all pixels are turned on or off (to provide a solid display) is increased in each of the frames to provide temporal and spatial uniformity of display.

For example, as described in Japanese Patent No. 3582919, when four-frame five-gradation display was performed using a light pattern with two rows and two columns shown in Table 1, the solid probability was 50.0% and the on/off probability was 50.0%. As a result, the number of gradations was reduced, and natural appearance in video display was lost although almost no flicker was generated and very uniform display was provided.

TABLE 1

| First Frame | | Second Frame | | Third Frame | | Fourth Frame | |
|---|---|---|---|---|---|---|---|
| 4 | 7 | 7 | 0 | 0 | 3 | 3 | 4 |
| 3 | 0 | 4 | 3 | 7 | 4 | 0 | 7 |

It is conceived that the occurrence of crosstalk or flicker is reduced according to Japanese Patent No. 3582919. However, because the ON/OFF state of each pixel is fixed in one frame, a pattern with, for example, two rows and two columns is repeated. Therefore, an undesired FRC waving pattern or blinking pattern, as described below, inevitably occurs.

### SUMMARY

Various exemplary embodiments disclosed herein provide a simple-matrix liquid crystal driving method, a liquid crystal driver, and a liquid crystal display apparatus capable of significantly reducing or preventing the occurrence of an undesired FRC waving pattern and blinking pattern without increasing power consumption.

An exemplary embodiment disclosed herein provides a method for driving a simple-matrix liquid crystal panel in which every three row electrodes of the liquid crystal panel are simultaneously driven by a multi-line addressing drive system using an orthogonal matrix and four gradations per pixel of the liquid crystal panel are displayed for an equivalent time to three frames by a frame-rate-control gradation system. The method includes using a cyclic orthogonal matrix with three rows and four columns as the orthogonal matrix; generating three gradation palettes having different phases of ON/OFF data of intermediate gradations; generating a frame-rate-control phase table for an entire screen of the liquid crystal panel in which the three gradation palettes are distributed so that a sequence direction of the ON/OFF data of the three gradation palettes coincides with a circulation direction of 1/−1 data of the cyclic orthogonal matrix, and assigning a predetermined gradation palette to each of the pixels of the liquid crystal panel; simultaneously updating frames of the frame-rate-control gradation system and column vectors of the cyclic orthogonal matrix on a field-by-field basis to perform drive control and gradation control of each of the pixels of the liquid crystal panel; and completing gradation display of each of the pixels of the liquid crystal panel for 12 fields constituting the three frames of the frame-rate-control gradation system.

Preferably, the frame-rate-control phase table is configured such that the three gradation palettes are distributed in both a row direction and a column direction.

Preferably, when the frame-rate-control phase table is generated, gradation palettes are distributed to two sets of three rows to be simultaneously driven so that the gradation palettes are assigned to alternate rows, and every three alternate rows to which the gradation palettes are assigned are simultaneously driven.

Another exemplary embodiment disclosed herein provides a method for driving a simple-matrix liquid crystal panel in which every seven row electrodes of the liquid crystal panel are simultaneously driven by a multi-line addressing drive system using an orthogonal matrix and eight gradations per pixel of the liquid crystal panel are displayed for an equivalent time to seven frames by a frame-rate-control gradation system. The method includes using a cyclic orthogonal matrix with seven rows and eight columns as the orthogonal matrix; generating seven gradation palettes having different phases of ON/OFF data of intermediate gradations; generating a frame-rate-control phase table for an entire screen of the liquid crystal panel in which the seven gradation palettes are distributed so that a sequence direction of the ON/OFF data of the seven gradation palettes coincides with a circulation direction of 1/−1 data of the cyclic orthogonal matrix, and assigning a predetermined gradation palette to each of the pixels of the liquid crystal panel; simultaneously updating frames of the frame-rate-control gradation system and column vectors of the cyclic orthogonal matrix on a field-by-field basis to perform drive control and gradation control of each of the pixels of the liquid crystal panel; and completing gradation display of each of the pixels of the liquid crystal panel for 56 fields constituting the seven frames of the frame-rate-control gradation system.

Preferably, the frame-rate-control phase table is configured such that the seven gradation palettes are distributed in both a row direction and a column direction.

Preferably, when the frame-rate-control phase table is generated, gradation palettes are distributed to two sets of seven rows to be simultaneously driven so that the gradation palettes are assigned to alternate rows, and every seven alternate rows to which the gradation palettes are assigned are simultaneously driven.

The exemplary embodiments disclosed herein also provide a liquid crystal driver using the simple-matrix liquid crystal driving method described above, wherein the liquid crystal driver performs drive control and gradation control of the liquid crystal panel using the simple-matrix liquid crystal driving method.

The exemplary embodiments disclosed herein further provide a liquid crystal display apparatus including the liquid crystal panel, and the above-described liquid crystal driver, wherein the liquid crystal driver performs drive control and gradation control of the liquid crystal panel.

According to the exemplary embodiments, the fields of ON/OFF state are temporally and spatially dispersed, resulting in less occurrence of flicker. Further, the effective voltage difference for each field is small, which reduces crosstalk. Therefore, the instantaneous occurrence of an undesired FRC waving pattern or blinking pattern can be reduced or prevented. Further, column vectors of a cyclic orthogonal matrix are merely updated on a field-by-field basis, thus achieving advantages of a small number of additional circuits and no increase in power consumption.

### BRIEF DESCRIPTION OF THE DRAWINGS

FIG. 1 is a schematic block diagram showing a liquid crystal driver using a simple-matrix liquid crystal driving method according to an embodiment;

FIG. 2 is a schematic diagram showing FRC gradation palettes A, B, and C used in the liquid crystal driver shown in FIG. 1; and

FIG. 3 is a conceptual diagram showing the operation of the liquid crystal driver shown in FIG. 1.

### DETAILED DESCRIPTION OF EMBODIMENTS

A simple-matrix liquid crystal driving method, a liquid crystal driver, and a liquid crystal display apparatus according to various exemplary embodiments will be described in detail with reference to the accompanying drawings.

As a countermeasure against the occurrence of flicker, the inventors have developed a technique that uses an ON/OFF data dispersion system for spatially and temporally dispersing ON/OFF frames for each pixel. For example, in the case of four-gradation display, three frames are needed. Therefore, three gradation palettes A to C having different arrangements of ON/OFF data are prepared, and the gradation palettes A to C are cyclically assigned to the pixels, as shown in Table 2 below.

TABLE 2

| | SEG1 | SEG2 | SEG3 | SEG4 | SEG5 | SEG6 | SEG7 | . . . |
|---|---|---|---|---|---|---|---|---|
| 1Line | A | B | C | A | B | C | A | . . . |
| 2Line | B | C | A | B | C | A | B | . . . |
| 3Line | C | A | B | C | A | B | C | . . . |
| . | . | . | . | . | . | . | . | . . . |
| . | . | . | . | . | . | . | . | |
| . | . | . | . | . | . | . | . | |

This system can prevent the occurrence of flicker. However, if an LCD on which an intermediate-gradation solid image is displayed is physically shaken, a light-and-dark pattern (hereinafter referred to as an “FRC waving pattern”) corresponding to the spatial distribution of the ON/OFF data appears when the shaking is synchronized with the frame frequency of an image being displayed. In the case of blinking display in which an intermediate-gradation solid image is displayed and the gradation of the image is inverted, a light-and-dark pattern (hereinafter referred to as a “blinking pattern”) can also be visually perceived at the moment of switching.

The FRC waving pattern or blinking pattern occurs, despite identical effective voltages for all the pixels after one display cycle, because each of the ON or OFF pixels is displayed in every frame, which results in a large effective voltage difference for each pixel between frames or fields of the FRC gradation system. A countermeasure against such an undesired pattern is to minimize the effective voltage difference for each pixel between the frames or fields.

According to the exemplary embodiments, a cyclic orthogonal matrix is used and phases of the FRC gradation system are set (e.g., by setting gradation tables to be assigned to the pixels) so as to provide substantially uniform transition of effective voltages for pixels on a plurality of rows to be simultaneously driven. Consequently, frames of the FRC gradation system can be temporally distributed. In the exemplary embodiments, the above-described display system is referred to as an “FRC frame dispersion system” (hereinafter also referred to as an “exemplary system”).

The FRC frame dispersion system according to the exemplary embodiments will be described.

A first embodiment of the exemplary embodiments is substantially suitable for use in the case where three rows are simultaneously driven using the MLA drive system and four gradations are displayed for a time period of three frames using the FRC gradation system, and the case where seven rows are simultaneously driven and eight gradations are displayed for a time period of seven frames. The exemplary embodiments can also be applied to the case where a plurality of rows more than those described above, such as 11 rows, are simultaneously driven and 12 gradations are displayed for a time period of 11 frames.

The following description will be made in the context of an LCD including a liquid crystal panel having 120 row electrodes defining rows and 160 column electrodes defining columns, and a liquid crystal driver for driving the liquid crystal panel, wherein three rows are simultaneously driven and four gradations are displayed for a time period of three frames, unless stated otherwise.

First, a cyclic orthogonal matrix will be described. Table 3 below is a cyclic orthogonal matrix with three rows and four columns used in the exemplary embodiment. In a liquid crystal driver of simple-matrix liquid crystal for simultaneously driving a plurality of rows using a conventional MLA drive system, an orthogonal matrix such as a Walsh function or an Hadamard matrix is used. In the exemplary system, on the other hand, a cyclic orthogonal matrix such as an M-sequence matrix or a Paley matrix is used. In Table 3, “1” or “−1” corresponds to a row-electrode voltage of the LCD, wherein “1” represents a positive row-electrode voltage (+Vr) and “−1” represents a negative row-electrode voltage (−Vr).

TABLE 3

| | R0 | R1 | R2 | R3 |
|---|---|---|---|---|
| L1 | −1 | 1 | 1 | −1 |
| L2 | 1 | −1 | 1 | −1 |
| L3 | 1 | 1 | −1 | −1 |

In the cyclic orthogonal matrix with three rows and four columns shown in Table 3, data is circulated (shifted or rotated) in both the row and column directions within a range of the column vectors R0 to R2. That is, the first column vector R0 is (−1, 1, 1). The first column vector R0 is shifted to the second column vector R1, and also shifted one bit down so that the second column vector R1 is (1, −1, 1). Likewise, the third column vector R2 is (1, 1, −1).

Although the cyclic orthogonal matrix shown in Table 3 is initially a complete cyclic orthogonal matrix with four rows and four columns, one line on the fourth row is deleted because of three-row simultaneous driving. Further, all 3 bits of the fourth column vector R3 are set to −1 to balance the numbers of 1's and −1's of the bits of the rows L1 to L3. In the case of three-row simultaneous driving, the bit sequence (the sequence of 1's and −1's) in the cyclic orthogonal matrix is only implemented by the combination shown in Table 3.

Therefore, the 4 bits of the first row vector L1 are set to −1, 1, 1, and −1, and two −1's and two 1's are used. That is, the numbers of −1's and 1's are equal, i.e., two. The same applies to the second and third row vectors L2 and L3.

In the case where seven rows are simultaneously driven using the MLA drive system and eight gradations are displayed for a time period of seven frames using the FRC gradation system, a cyclic orthogonal matrix with seven rows and eight columns is used, as shown below in, for example, Table 4. Also in this case, all 7 bits of an eighth column vector R7 are set to 1 to balance the numbers of 1's and −1's of the bits of the rows L1 to L7. In the case of seven-row simultaneous driving, the bit sequence in the cyclic orthogonal matrix can be implemented by various combinations other than that shown in Table 4.

TABLE 4

| | R0 | R1 | R2 | R3 | R4 | R5 | R6 | R7 |
|---|---|---|---|---|---|---|---|---|
| L1 | −1 | −1 | −1 | 1 | −1 | 1 | 1 | 1 |
| L2 | 1 | −1 | −1 | −1 | 1 | −1 | 1 | 1 |
| L3 | 1 | 1 | −1 | −1 | −1 | 1 | −1 | 1 |
| L4 | −1 | 1 | 1 | −1 | −1 | −1 | 1 | 1 |
| L5 | 1 | −1 | 1 | 1 | −1 | −1 | −1 | 1 |
| L6 | −1 | 1 | −1 | 1 | 1 | −1 | −1 | 1 |
| L7 | −1 | −1 | 1 | −1 | 1 | 1 | −1 | 1 |

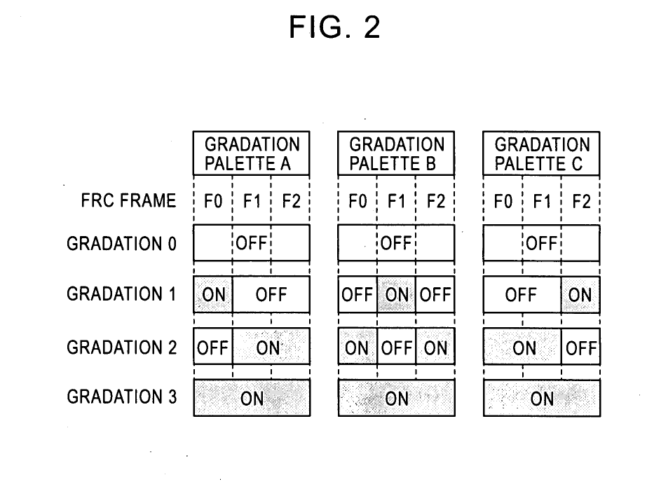

In the exemplary system, as shown in FIG. 2, three gradation palettes A, B, and C having different phases (sequences) of ON/OFF data of intermediate gradations are generated. The gradation palettes A to C are distributed so that the arrangement direction of the ON/OFF data of the gradation palettes A to C can coincide with the circulation direction of the 1/−1 data of the cyclic orthogonal matrix, and an FRC phase table pattern with three rows and three columns is generated, as shown in Table 5 below.

TABLE 5

| | | Column | | |
|---|---|---|---|---|
| | | 1 | 2 | 3 |
| Row | 1 | A | B | C |
| | 2 | B | C | A |
| | 3 | C | A | B |

The circulation direction of the data of the cyclic orthogonal matrix is a direction in which, as described above, the 1/−1 data is shifted one bit in both the row direction (i.e., down) and the column direction (i.e., to the right). In the example shown in Table 3, as can be seen from the sequence of −1's, the circulation direction is a down-right direction.

The arrangement direction of the ON/OFF data of the gradation palettes A to C will be examined in the context of, for example, the cases where assignment patterns A-C-B and C-A-B of the gradation palettes A to C to be assigned to three rows using an FRC phase table. In the case of the assignment pattern A-C-B of the gradation palettes A to C, the arrangement of the ON/OFF data of gradation 2 is shown in Table 6 below. In the case of the assignment pattern C-A-B of the gradation palettes A to C, the arrangement of the ON/OFF data of gradation 2 is shown in Table 7 below. “1” and “−1” represent ON and OFF, respectively.

TABLE 6

| | F0 | F1 | F2 | F0 | F1 | F2 |
|---|---|---|---|---|---|---|
| A | −1 | 1 | 1 | −1 | 1 | 1 |
| C | 1 | 1 | −1 | 1 | 1 | −1 |
| B | 1 | −1 | 1 | 1 | −1 | 1 |

TABLE 7

| | F0 | F1 | F2 | F0 | F1 | F2 |
|---|---|---|---|---|---|---|
| C | 1 | 1 | −1 | 1 | 1 | −1 |
| A | −1 | 1 | 1 | −1 | 1 | 1 |
| B | 1 | −1 | 1 | 1 | −1 | 1 |

That is, in the case of the assignment pattern A-C-B of the gradation palettes A to C, as can be seen from the sequences of −1's, the arrangement direction of the ON/OFF data based on the gradation palettes A, C, and B is an up-right direction, which does not coincide with the circulation direction of the data of the cyclic orthogonal matrix. In the case of the assignment pattern C-A-B of the gradation palettes A to C, the arrangement direction of the ON/OFF data based on the gradation palettes C, A, and B is a down-right direction, which coincides with the circulation direction of the data of the cyclic orthogonal matrix.

In the exemplary system, as described above, the gradation palettes A to C are distributed so that the arrangement direction of the ON/OFF data based on the gradation palettes A to C coincides with the circulation direction of the data of the cyclic orthogonal matrix.

It is sufficient that the gradation palettes may be distributed to one column, i.e., only in the row direction, to distribute the frames of the FRC gradation system. That is, the gradation palettes A to C for columns 1 to 3 may only be arranged in the order of A, B, and C. In the FRC phase table pattern shown in Table 5, the gradation palettes A to C in columns 1 to 3 are also distributed in the column direction (i.e., B-C-A in column 2 and C-A-B in column 3) to prevent the occurrence of flicker due to the time-series biased concentration.

In the case where seven rows are simultaneously driven using the MLA drive system and eight gradations are displayed for a time period of seven frames using the FRC gradation system, seven gradation palettes A, B, C, D, E, F, and G (not shown) having different phases of ON/OFF data of intermediate gradations are generated. The seven gradation palettes A to G are also distributed so that the arrangement direction of the ON/OFF data of the gradation palettes A to G can coincide with the circulation direction of the 1/−1 data of the cyclic orthogonal matrix, and an FRC phase table pattern with seven rows and seven columns is generated, as shown in, for example, Table 8 below.

TABLE 8

| Column | | | | | | |
|---|---|---|---|---|---|---|
| 1 | 2 | 43 | 4 | 5 | 6 | 7 |

| | | | | | | | | |
|---|---|---|---|---|---|---|---|---|
| Row | 1 | A | C | E | G | B | D | F |
| | 2 | B | D | F | A | C | E | G |
| | 3 | C | E | G | B | D | F | A |
| | 4 | D | F | A | C | E | G | B |
| | 5 | E | G | B | D | F | A | C |
| | 6 | F | A | C | E | G | B | D |
| | 7 | G | B | D | F | A | C | E |

The FRC phase table pattern shown in Table 5 is cyclically repeated for the pixels in the entire screen of the liquid crystal panel to generate an FRC phase table for the entire screen of the liquid crystal panel. A predetermined gradation palette selected from the gradation palettes A to C is assigned to each of the pixels of the liquid crystal panel. In the exemplary embodiment, the display screen of the liquid crystal panel has 120 rows and 160 columns, and an FRC phase table shown in Table 9 below is generated.

TABLE 9

| | | Column | | | | | | | |
|---|---|---|---|---|---|---|---|---|---|
| | | 1 | 2 | 3 | 4 | 5 | 6 | | 160 |
| Row | 1 | A | B | C | A | B | C | | A |
| | 2 | B | C | A | B | C | A | | B |
| | 3 | C | A | B | C | A | B | | C |
| | 4 | A | B | C | A | B | C | | A |
| | 5 | B | C | A | B | C | A | . . . | B |
| | 6 | C | A | B | C | A | B | | C |
| | | | | | . | | | | |
| | | | | | . | | | | |
| | | | | | . | | | | |
| | 119 | B | C | A | B | C | A | | B |
| | 120 | C | A | B | C | A | B | | C |

A group for the frame distribution of the FRC gradation system in the row direction (i.e., A-B-C, B-C-A, or C-A-B) causes temporal biased concentration. It is desirable that three alternate rows be simultaneously driven, as shown in Table 10 below, to prevent continuation of biased concentration in the same column. Table 10 shows an exemplary FRC phase table pattern for simultaneously driving three odd-numbered rows (e.g., the first, third, and fifth rows) or three even-numbered rows (e.g., the second, fourth, and sixth rows).

TABLE 10

| | | Column | | |
|---|---|---|---|---|
| | | 1 | 2 | 3 |
| Row | 1 | A | B | C |
| | 2 | C | A | B |
| | 3 | B | C | A |
| | 4 | A | B | C |
| | 5 | C | A | B |
| | 6 | B | C | A |

The FRC phase table pattern shown in Table 10 is the same as that shown in Table 5 when viewed on the three odd-numbered rows (e.g., the first, third, and fifth rows) to be simultaneously driven. One the other hand, when viewed on the three even-numbered rows (e.g., the second, fourth, and sixth rows) to be simultaneously driven, the first to third even-numbered rows correspond to the third, first, and second rows shown in Table 5, respectively. The sequences of three odd-numbered rows and three even-numbered rows are not limited to those shown in Table 10, and any combination may be used as far as the gradation palettes designated in columns 1 to 3 in Table 5 are shifted in the column direction.

That is, in the case of three-row simultaneous driving, when an FRC phase table pattern or an FRC phase table is generated, gradation palettes are distributed in two sets (i.e., a pair) of three rows (for a total of six rows) to be simultaneously driven so that the gradation palettes are assigned to alternate rows, and three alternate rows are simultaneously driven. Also in the case of seven-row simultaneous driving, when an FRC phase table pattern or an FRC phase table is generated, gradation palettes are distributed in two sets of seven rows (for a total of 14 rows) to be simultaneously driven so that the gradation palettes are assigned to alternate rows, and seven alternate rows are simultaneously driven.

In the above-described example, an FRC phase table pattern that is a basic gradation-table assignment pattern with a small number of rows and columns is generated, and is cyclically repeated for the pixels of the entire screen of the liquid crystal panel to generate an FRC phase table for the entire screen of the liquid crystal panel. However, an FRC phase table for the entire screen of the liquid crystal panel can be generated without generating an FRC phase table pattern.

Next, a conventional system (e.g., an ON/OFF data distribution system) using a combination of the MLA drive system and the FRC gradation system is compared to an FRC frame dispersion system according to the exemplary embodiments (hereinafter also referred to as the “exemplary system”) will be described using three-row simultaneous driving with four-gradation display.

In the conventional ON/OFF data distribution system, an MLA calculation given by the expression below and shown in Table 11 is performed in a time-series manner, during which one display cycle of FRC is completed. The ON/OFF operation of each pixel is completed during every frame of the FRC gradation system. Therefore, in the ON/OFF data distribution system, a column vector (R) of an orthogonal matrix is updated on a field-by-field basis each time a frame (F) of the FRC gradation system is updated.

F0*R0→F0*R1→F0*R2→F0*R3→F1*R0→F1*R1→F1*R2→F1*R3→F2*R0→F2*R1→F2*R2→F2*R3

The order of the MLA calculation is shown in Table 11 below.

TABLE 11
Order of Conventional MLA Calculation

| | R0 | R1 | R2 | R3 |
|---|---|---|---|---|
| F0 | 1 | 2 | 3 | 4 |
| F1 | 5 | 6 | 7 | 8 |
| F2 | 9 | 10 | 11 | 12 |

F0, F1, and F2 indicate frames of the FRC gradation system, the asterisk (*) indicates an MLA calculation, and R0, R1, R2, and R3 indicate column vectors of the orthogonal matrix. An MLA calculation includes calculating a sum of products between the ON/OFF data (F) on the respective columns in a plurality of rows to be simultaneously driven and the column vectors (R) of the orthogonal matrix. Specifically, the ON data is represented by 1 and the OFF data is represented by −1. The ON data and the OFF data are multiplied bitwise by the column vectors of the orthogonal matrix, and the results are summed.

In the exemplary system, on the other hand, a calculation given by the expression below and shown in Table 12 is performed in a time-series manner. In the exemplary system, the ON/OFF operation of each pixel is not completed for every frame of the FRC gradation system, but is completed for 12 fields constituting three frames, which are all frames of the FRC gradation system. That is, in the exemplary system, both the frames (F) of the FRC gradation system and the column vectors (R) of the cyclic orthogonal matrix are simultaneously updated (or shifted) on a field-by-field basis.

F0*R0→F1*R1→F2*R2→F0*R3→F1*R0→F2*R1→F0*R2→F1*R3→F2*R0→F0*R1→F1*R2→F2*R3

The order of the MLA calculation in the exemplary system is as shown in Table 12 below.

TABLE 12
Order of MLA Calculation of the Exemplary System

| | R0 | R1 | R2 | R3 |
|---|---|---|---|---|
| F0 | 1 | 10 | 7 | 4 |
| F1 | 5 | 2 | 11 | 8 |
| F2 | 9 | 6 | 3 | 12 |

F0, F1, and F2 indicate frames of the FRC gradation system, the asterisk (*) indicates an MLA calculation, and R0, R1, R2, and R3 indicate column vectors of the cyclic orthogonal matrix. In one aspect, the exemplary system differs from the conventional ON/OFF data distribution system in that the exemplary system uses a cyclic orthogonal matrix as an orthogonal matrix and makes the MLA calculations in a different order. The final effective voltages in the exemplary system and the ON/OFF data distribution system are equivalent to each other. However, the exemplary system achieves an advantage of smaller effective voltage difference between pixels of the same gradation per time.

Next, the FRC frame distribution system according to the exemplary embodiments will be specifically described in the context where three rows are simultaneously driven using a cyclic orthogonal matrix having three rows and four columns and one display cycle of the liquid crystal panel is completed for 12 fields (i.e., 3 frames×4 fields).

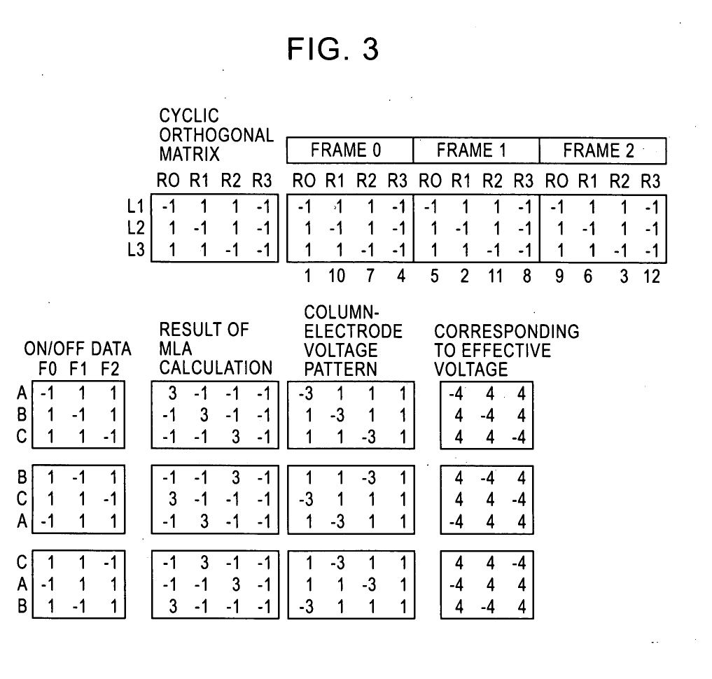

FIG. 3 illustrates exemplary results of an MLA calculation performed on each of three columns for gradation 2 using the FRC phase table pattern shown in Table 5. Specifically, FIG. 3 illustrates a cyclic orthogonal matrix with three rows and four columns, cyclic orthogonal matrices used in each of the three frames, ON/OFF data of the gradation, MLA calculation results, column-electrode voltage patterns, and values corresponding to effective voltages.

The cyclic orthogonal matrix is based on the cyclic orthogonal matrix with three rows and four columns as shown in Table 3. The cyclic orthogonal matrices used in frames 0, 1, and 2 of the FRC gradation system are each based on the matrix shown in Table 3. The numbers shown below the cyclic orthogonal matrices for frames 0 to 2 of the FRC gradation system are field numbers.

In the ON/OFF data shown in FIG. 3, the ON/OFF data of gradation 2 of the gradation palettes A, B, and C as shown in FIG. 2 is represented by 1 and −1 according to the gradation palette specified by the FRC phase table pattern as shown in Table 5. In FIG. 3, the top set of ON/OFF data corresponds to the first column of the FRC phase table pattern as shown in Table 5, and the middle and bottom sets of ON/OFF data correspond to the second and third columns, respectively.

For example, the three data elements in the first column of the FRC phase table pattern are A, B, and C. In the top set of ON/OFF data, the ON/OFF data for each frame of gradation 2 of the gradation palettes A, B, and C is represented by 1 and −1 according to the three data elements A, B, and C. That is, the data elements at gradation 2 of the gradation palette A are OFF, ON, and ON, and therefore the A-th row of the set of ON/OFF data is (−1, 1, 1). The same applies to the other ON/OFF data.

The MLA calculation results indicate results of an MLA calculation between the ON/OFF data and the cyclic orthogonal matrices. The first row of the MLA calculation results indicate results of a product-sum operation between the ON/OFF data and the column vectors R0 to R3 of the cyclic orthogonal matrix for frame F0. The second and third rows of the MLA calculation results indicate results of a product-sum operation between the ON/OFF data and the column vectors R0 to R3 of the orthogonal matrices for frames F1 and F2, respectively.

For example, in the top set of ON/OFF data, the MLA calculation of F0*R0 is performed by determining a product (=1) of −1 at the intersection between A and F0 of the set of ON/OFF data and −1 at the intersection between the L1 and R0 of the cyclic orthogonal matrix for frame 0, a product (=1) of 1 at the intersection between B and F0 and 1 at the intersection between L2 and R0, and a product (=1) of 1 at the intersection between C and F0 and 1 at the intersection between L3 and R0, and summing the products, i.e., 1+1+1=3, which is set as the value on the first row and first column of the MLA calculation results.

In the MLA calculation results, the four calculation results in the first row indicate the results of the MLA calculations of F0*R0, F0*R1, F0*R2, and F0*R3. The four calculation results in the second row indicate the results of the calculations of F1*R0, F1*R1, F1*R2, and F1*R3, and the calculation results in the third row indicate the results of the calculations of F2*R0, F2*R1, F2*R2, and F2*R3.

The column-electrode voltage patterns are generated by inverting the signs of the corresponding MLA calculation results, and actually represent the voltage levels to be applied to the column electrodes. In the example shown in FIG. 3, two voltage levels corresponding to “−3” and “1” are applied to the column electrodes.

The correspondence to effective voltages indicates values corresponding to effective voltages. The first row of the values corresponding to effective voltages are determined by inverting results of a product-sum operation between the first row L1 of the cyclic orthogonal matrix and the rows of the column-electrode voltage patterns. The second and third rows of the values corresponding to effective voltages are also determined by inverting results of a product-sum operation between the second and third rows L2 and L3 of the cyclic orthogonal matrix and the rows of the column-electrode voltage patterns, respectively.

For example, the first row (−4, 4, 4) of the top set of values corresponding to effective voltages is obtained by determining results of a product-sum operation between the first row L1 (−1, 1, 1, −1) of the cyclic orthogonal matrix and the data corresponding to the first row (−3, 1, 1, 1), the second row (1, −3, 1, 1), and the third row (1, 1, −3, 1) of the corresponding column-electrode voltage pattern, and inverting the sum. The second and third rows of the top set of values corresponding to effective voltages and the rows of the other sets of values corresponding to effective voltages are also obtained in a similar manner.

As a result, as shown in FIG. 3, all ON data (i.e., 1) in the ON/OFF data are set to 4 as the data of the sets of values corresponding to effective voltages. All OFF data (i.e., −1) of the sets of ON/OFF data are set to −4 as the data of the values corresponding to effective voltages. That is, it is to be understood that the ON data and OFF data of the ON/OFF data are completely restored in the values corresponding to effective voltages.

Next, the difference between the exemplary system and the ON/OFF data distribution system will be described.

Table 13 below indicates the transition of the effective voltage of each pixel in the ON/OFF data distribution system, for the three gradation patterns (A-B-C, B-C-A, and C-A-B), with respect to each field. The values in each of the fields 1 to 12 are obtained by multiplying the orthogonal matrix to be applied by the corresponding column-electrode voltage pattern, inverting the signs of the multiplication results, and sequentially adding (i.e., accumulating) the results to the effective voltages in the previous field.

TABLE 13

| FIELD | 1 | 2 | 3 | 4 | 5 | 6 | 7 | 8 | 9 | 10 | 11 | 12 |
|---|---|---|---|---|---|---|---|---|---|---|---|---|
| A | −3 | −4 | −5 | −4 | −3 | 0 | −1 | 0 | 1 | 0 | 3 | 4 |
| B | 3 | 4 | 3 | 4 | 3 | 0 | −1 | 0 | −1 | 0 | 3 | 4 |
| C | 3 | 2 | 3 | 4 | 3 | 6 | 7 | 8 | 7 | 6 | 3 | 4 |
| B | 1 | 0 | 3 | 4 | 1 | 0 | −1 | 0 | 1 | 4 | 3 | 4 |
| C | −1 | 0 | 3 | 4 | 7 | 8 | 7 | 8 | 7 | 4 | 3 | 4 |
| A | −1 | −2 | −5 | −4 | −1 | −2 | −1 | 0 | −1 | 2 | 3 | 4 |
| C | 1 | 4 | 3 | 4 | 5 | 4 | 7 | 8 | 5 | 4 | 3 | 4 |
| A | −1 | −4 | −5 | −4 | −5 | −4 | −1 | 0 | 3 | 4 | 3 | 4 |
| B | −1 | 2 | 3 | 4 | 3 | 2 | −1 | 0 | 3 | 2 | 3 | 4 |
| MIN | −3 | −4 | −5 | −4 | −5 | −4 | −1 | 0 | −1 | 0 | 3 | 4 |
| MAX | 3 | 4 | 3 | 4 | 7 | 8 | 7 | 8 | 7 | 6 | 3 | 4 |
| DIFFERENCE | 6 | 8 | 8 | 8 | 12 | 12 | 8 | 8 | 8 | 6 | 0 | 0 |

In any of the three gradation patterns, the values in the last field, namely, field 12, are set to 4. However, it is found that the value of the effective voltage difference (MAX-MIN) for each field is large even at the same gradation and the maximum value is 12. An effective voltage difference of 8 corresponds to one gradation, and an effective voltage difference of 12 corresponds to 1.5 gradations. Such effective voltage differences are instantaneously perceived as an FRC waving pattern or blinking pattern.

Table 14 below indicates the transition of the effective voltage for each pixel in the exemplary system with respect to each field. The values in each of fields 1 to 12 are also obtained by multiplying the cyclic orthogonal matrix to be applied by the corresponding column-electrode voltage pattern, inverting the signs of the multiplication results, and sequentially adding the results to the effective voltages in the previous field. The maximum value of the effective voltage differences for the fields is 8, resulting in a substantially imperceptible FRC waving pattern or blinking pattern.

TABLE 14

| FIELD | 1 | 2 | 3 | 4 | 5 | 6 | 7 | 8 | 9 | 10 | 11 | 12 |
|---|---|---|---|---|---|---|---|---|---|---|---|---|
| A | −3 | 0 | 3 | 4 | 5 | 4 | 3 | 4 | 5 | 4 | 3 | 4 |
| B | 3 | 0 | 3 | 4 | 3 | 4 | 3 | 4 | 3 | 4 | 3 | 4 |
| C | 3 | 6 | 3 | 4 | 3 | 2 | 3 | 4 | 3 | 2 | 3 | 4 |
| B | 1 | 0 | −1 | 0 | −3 | 0 | 3 | 4 | 5 | 4 | 3 | 4 |
| C | −1 | 0 | −1 | 0 | 3 | 0 | 3 | 4 | 3 | 4 | 3 | 4 |
| A | −1 | −2 | −1 | 0 | 3 | 6 | 3 | 4 | 3 | 2 | 3 | 4 |
| C | 1 | 0 | −1 | 0 | 1 | 0 | −1 | 0 | −3 | 0 | 3 | 4 |
| A | −1 | 0 | −1 | 0 | −1 | 0 | −1 | 0 | 3 | 0 | 3 | 4 |
| B | −1 | −2 | −1 | 0 | −1 | −2 | −1 | 0 | 3 | 6 | 3 | 4 |
| MIN | −3 | −2 | −1 | 0 | −3 | −2 | −1 | 0 | −3 | 0 | 3 | 4 |
| MAX | 3 | 6 | 3 | 4 | 5 | 6 | 3 | 4 | 5 | 6 | 3 | 4 |
| DIFFERENCE | 6 | 8 | 4 | 4 | 8 | 8 | 4 | 4 | 8 | 6 | 0 | 0 |

In the case where seven rows are simultaneously driven using the MLA drive system and eight gradations are displayed for a time period of seven frames using the FRC gradation system, one display cycle is completed for 56 fields (e.g., 7 frames×8 fields). In this case, the ON/OFF data distribution system requires eight column-electrode voltage patterns. Here, the FLA7 drive system (see Japanese Patent No. 3719973) was used to reduce the number of column-electrode voltage patterns to four, which is half that conventionally required.

In the case of seven-row simultaneous driving, the amount of data is significantly large, and only the results are described. The transition of similar effective voltages at gradation 3 was examined. In the ON/OFF data distribution system, the effective voltage difference for each field was large, and the maximum difference was 30, which corresponds to 3.75 gradations. In the exemplary system, on the other hand, the effective voltage difference for each field was small, and the maximum difference was 16, resulting in a substantially imperceptible FRC waving pattern or blinking pattern.

In the exemplary system, the fields of ON/OFF state are temporally and spatially dispersed, which reduces flicker. Further, the effective voltage difference for each field is smaller than that in the ON/OFF data distribution system, which reduces crosstalk. Therefore, the instantaneous occurrence of an FRC waving pattern or blinking pattern can be reduced or prevented. Further, both the frames of the FRC gradation system and the column vectors of the cyclic orthogonal matrix are merely updated on a field-by-field basis, thus achieving advantages of a small number of additional circuits and no increase in power consumption.

It is to be noted that it is difficult to use the FRC frame distribution system according to the exemplary embodiments in the APT (Alt & Pleshko Technique) drive system commonly used for simple-matrix liquid crystal. The exemplary system is effective for the use of the MLA drive system and the FRC gradation system and under the following two conditions:

(1) Three rows are simultaneously driven, and four gradations are displayed for a time period of three frames.

(2) Seven rows are simultaneously driven, and eight gradations are displayed for a time period of seven frames.

Next, the liquid crystal driver according to the exemplary embodiments will be described with respect to a specific example.

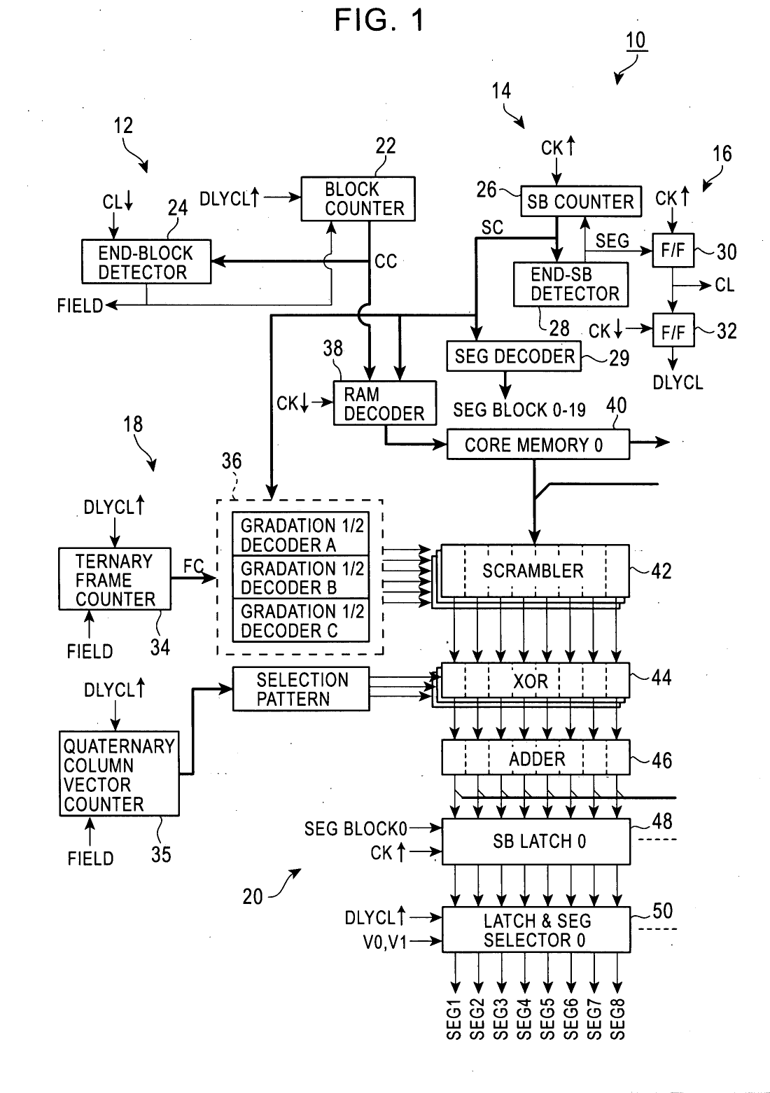

FIG. 1 is a schematic block diagram showing a liquid crystal driver 10 using the simple-matrix liquid crystal driving method according to an exemplary embodiment. As described above, the liquid crystal driver 10 shown in FIG. 1 is used in an LCD using a simple-matrix liquid crystal panel having 120 rows of electrodes and 160 columns of electrodes for simultaneously driving three row electrodes using a cyclic orthogonal matrix with three rows and four columns using the MLA drive system and displaying four gradations per pixel of the liquid crystal panel for a time period of three frames using the FRC gradation system.

The liquid crystal driver 10 shown in FIG. 1 includes a common-block control circuit 12, a segment-block control circuit 14, a timing signal generation circuit 16, a gradation control circuit 18, and a column electrode driving circuit 20.

In the exemplary embodiment, the 120 rows of the liquid crystal panel are divided into 40 common blocks 0 to 39 each having three rows, and the 160 columns are divided into 20 segment blocks 0 to 19 each having eight columns to perform drive control and gradation control. In the liquid crystal driver 10 shown in FIG. 1, for ease of description, a row electrode driving circuit is not illustrated, and only one segment block (SB) 0 in the column electrode driving circuit 20 is illustrated.

In the exemplary embodiment, as described above, three row electrodes are simultaneously selected using the MLA drive system to control the driving of the liquid crystal panel. In this case, one frame includes four fields, which is the same number as the number of column vectors of the cyclic orthogonal matrix. In the case where four gradations are displayed per pixel using the FRC gradation system, a time period of three frames, which is given by subtracting one from the number of gradations, is required to display the gradation of an image displayed on one screen.

Accordingly, as in the exemplary embodiment, when three row electrodes are simultaneously selected using the MLA drive system to drive the liquid crystal panel and four gradations are displayed per pixel using the FRC gradation system, 12 fields are required to complete the display of an image of one screen. For example, the 12 fields require three frames to display the gradations of an image displayed on one screen using the FRC gradation system, where each frame includes four fields for displaying an ON/OFF state of the image using the MLA drive system.

The common-block control circuit 12 includes a block counter 22, and an end-block detector 24.

The block counter 22 sequentially counts up from 0 to 39 in synchronization with the rising edge (as indicated by an upward arrow) of a signal DLYCL, and outputs a count value as a common count signal (CC signal). The CC signal is input to the end-block detector 24 and a RAM decoder 38.

The end-block detector 24 operates in synchronization with the falling edge (indicated by a downward arrow) of a signal CL, and detects whether or not the value of the CC signal is 39, which indicates the last common block of each field. Upon detecting that the value of the CC signal is 39, the end-block detector 24 outputs a detection signal FIELD that is in an active state. The detection signal FIELD is input to the block counter 22, a ternary frame counter 34, and a quaternary column vector counter 35.

In the block counter 22, when the detection signal FIELD is driven to the active state (e.g., to a high level), the value of the CC signal is reset to 0 in synchronization with the rising edge of the signal DLYCL. For a time period during which the detection signal FIELD is kept in a non-active state (e.g., in a low level), the block counter 22 counts up by one in synchronization with the rising edge of the signal DLYCL. As a result, the block counter 22 repeats counting within a range of values 0 to 39 of the CC signal.

The segment-block control circuit 14 includes an SB counter 26, an end-SB detector 28, and a SEG (segment) decoder 29.

The SB counter 26 sequentially counts up from 0 to 19 in synchronization with the rising edge of a signal CK, and outputs a count value as a segment count signal (i.e., SC signal). The SC signal is input to the end-SB detector 28, the SEG decoder 29, and the RAM decoder 38.

The end-SB detector 28 detects whether or not the value of the SC signal is 19, which indicates the last segment block of each row. Upon detecting that the value of the signal is 19, the end-SB detector 28 outputs a detection signal SEG that is in an active state. The detection signal SEG is input to the SB counter 26 and a flip-flop (F/F) 30.

Thus, in the SB counter 26, when the detection signal SEG is driven to the active state (e.g., to a high level), the value of the SC signal is reset to 0 in synchronization with the rising edge of the signal CK. For a period during which the detection signal SEG is kept in a non-active state (e.g., in a low-level), the SB counter 26 counts up in synchronization with the rising edge of the signal CK. As a result, the SB counter 26 repeats counting within a range of values 0 to 19 of the SC signal.

The SEG decoder 29 decodes the value of the SC signal, and outputs SEG block signals 0 to 19. The SEG block signals 0 to 19 are signals for driving the corresponding segment blocks 0 to 19 to an active state, and are in an active state (e.g., to a high level) when the values of the SC signal are 0 to 19, respectively. The SEG block signals 0 to 19 are input to SB latches 48 for the segment blocks 0 to 19 (not shown), respectively.

The timing signal generation circuit 16 includes two flip-flops (F/Fs) 30 and 32.

The flip-flop 30 holds the detection signal SEG in synchronization with the rising edge of the signal CK, and outputs the held signal as a signal CL. The signal CL is input to the end-block detector 24 and the flip-flop 32.

The flip-flop 32 holds the signal CL in synchronization with the falling edge of the signal CK, and outputs the held signal as a signal DLYCL. The signal DLYCL is input to the block counter 22, the ternary frame counter 34, the quaternary column vector counter 35, and a latch & SEG selector 50.

Thus, the signal CL is generated by holding the detection signal SEG at the rising edge of the signal CK and performing timing adjustment, and the signal DLYCL is generated by holding the signal CL at the falling edge of the signal CK and performing timing adjustment. The signal CK is output at a time interval required for the processing of each of the segment blocks 0 to 19. The signals CL and DLYCL are output at a time interval required for the processing of each of the common blocks 0 to 39.

The gradation control circuit 18 includes the ternary frame counter 34, and a gradation decoder 36.

The ternary frame counter 34 sequentially counts up from 0 to 2 in synchronization with the rising edge of the signal DLYCL for the time period in which the detection signal FIELD is kept in the active state, and outputs a count value as a frame count signal (i.e., FC signal). When the value of the FC signal is 2, the ternary frame counter 34 resets the count value to 0 in synchronization with the rising edge of the signal DLYCL for the time period during which the next detection signal FIELD is kept in the active state. The FC signal is input to the gradation decoder 36.

The detection signal FIELD is a signal that is driven to the active state once every field. As a result, the ternary frame counter 34 counts up every field, and repeats counting within a range of values 0 to 2 of the FC signal.

The gradation decoder 36 includes gradation 1/2 decoders A, B, and C corresponding to the three gradation palettes A, B, and C shown in FIG. 2, respectively, and the FRC phase table shown in table 9 (not shown in FIG. 1). The three gradation palettes A to C have different arrangements of ON/OFF data.

The gradation decoder 36 outputs gradation pattern signals (ON/OFF data) corresponding to gradations 1 and 2, for 24 pixels (i.e., 3 rows×8 columns) included in the segment block specified by the value of the SC signal, using the value of the FC signal according to the gradation palette assigned by the FRC phase table. The gradation pattern signals are input to a scrambler 42.

Therefore, when the FC signal is 0, the gradation 1/2 decoder A outputs “1” (ON state) as the gradation pattern signal of gradation 1, and outputs “0” (OFF state) as the gradation pattern signal of gradation 2. When the FC signal is 1 and 2, the gradation 1/2 decoder A outputs “0” as the gradation pattern signal of gradation 1, and outputs “1” as the gradation pattern signal of gradation 2.

When the FC signal is 0 and 2, the gradation 1/2 decoder B outputs “0” as the gradation pattern signal of gradation 1, and outputs “1” as the gradation pattern signal of gradation 2. When the FC signal is 1, the gradation 1/2 decoder B outputs “1” as the gradation pattern signal of gradation 1, and outputs “0” as the gradation pattern signal of gradation 2.

When the FC signal is 0 and 1, the gradation 1/2 decoder C outputs “0” as the gradation pattern signal of gradation 1, and outputs “1” as the gradation pattern signal of gradation 2. When the FC signal is 2, the gradation 1/2 decoder C outputs “1” as the gradation pattern signal of gradation 1, and outputs “0” as the gradation pattern signal of gradation 2.

The gradation pattern signal of gradation 0 is always “0” (OFF state), and the gradation pattern signal of gradation 3 is always “1” (ON state). Therefore, the gradation decoder 36 does not need to output those gradation pattern signals.

The column electrode driving circuit 20 includes the RAM decoder 38, a core memory 40 (core memory 0), the scrambler 42, an XOR circuit 44, an adder 46, the SB latch 48 (SB latch 0), and the latch & SEG selector 50 (i.e., latch & SEG selector 0).

In FIG. 1, only the segment block 0 from the 20 segment blocks 0 to 19 is illustrated. The column electrode driving circuit 20 includes one RAM decoder 38, scrambler 42, XOR circuit 44, and adder 46. On the contrary, the column electrode driving circuit 20 includes one core memory 40, SB latch 48, and latch & SEG selector 50 for each of the segment blocks 0 to 19, that is, a total of 20 core memories 40, 20 SB latches 48, and 20 latch & SEG selectors 50.

The RAM decoder 38, the scrambler 42, the XOR circuit 44, and the adder 46 are therefore used for all the segment blocks 0 to 19 in a time-division manner.

The RAM decoder 38 operates in synchronization with the falling edge of the signal CK to decode a memory address of the core memory 40 to be processed on the basis of the information of the common block specified by the value from 0 to 39 of the CC signal and the information of the segment block specified by the value from 0 to 19 of the SC signal, and sequentially outputs the memory address. The memory address is input to the core memory 40.

The core memory 40 stores gradation data of the pixels for the 120 rows by the eight columns (in the case of the core memory 0, the first to eighth columns) of the liquid crystal panel. The same applies to the core memories 1 to 19. Gradation data of 48 bits for 24 pixels, i.e., 3 (the number of row electrodes to be simultaneously selected)×8 (the number of columns per segment block)×2 bits (the number of bits required to represent four gradations), are read at a time from the core memory 40. The gradation data is input to the scrambler 42.

The scrambler 42 includes three sets of scramblers for eight columns, which is equal to the number of row electrodes (i.e., three) to be simultaneously selected. The scrambler 42 outputs a 1-bit ON/OFF signal corresponding to each 2-bit gradation data on the basis of the gradation data of 48 bits for 24 pixels input from the core memory 40 and the gradation pattern signals input from the gradation decoder 36. The ON/OFF signals are input to the XOR circuit 44 in the subsequent stage.

If the gradation data is 0 (or 00 in binary notation) and 3 (or 11 in binary notation), as is apparent from the gradation patterns of the gradation palettes A, B, and C for gradations 0 and 3 shown in FIG. 2, the ON/OFF signals are fixed to 1 and 0 for all frames, respectively. Therefore, there is no influence on flicker or the like. If the gradation data is 1 (or 01 in binary notation) and 2 (or 10 in binary notation), the values of the ON/OFF signals are determined according to the gradation pattern signals. At gradations 1 and 2, there is an influence on flicker depending on the frame rate.

In the FRC phase table shown in Table 9, for example, the pixels in the first to third rows of the common block 0 on the first column (SEG1) are assigned to use the gradation palettes A, B, and C.

Therefore, in the case of the first column, for example, if the gradation data of the pixels in the first to third rows is 1, the ON/OFF signals for the first to third rows output from the scrambler 42 are set to 1, 0, and 0 when the FC signal is 0, to 0, 1, and 0 when the FC signal is 1, and to 0, 0, and 1 when the FC signal is 2. If the gradation data is 2, the ON/OFF signals for the first to third rows are set to 0, 1, and 1 when the FC signal is 0, to 1, 0, and 1 when the FC signal is 1, and to 1, 1, and 0 when the FC signal is 2.

The first column is exemplary, and the same applies to the remaining columns, namely, columns 2 to 160. The common block 0 is exemplary, and the same applies to the other common blocks 1 to 39.

The XOR circuit 44 includes eight sets of XOR circuits for three rows in correspondence with the scrambler 42. Each of the XOR circuits in the XOR circuit 44 receives a selection pattern of 3 bits. In the XOR circuit 44, an exclusive OR of each of the 3 bits of the selection pattern and each of the bits of the ON/OFF signals for the corresponding three rows is calculated, and output signals are input to the adder 46.

The selection pattern is a 3-bit column vector of the cyclic orthogonal matrix also used to determine a row-electrode voltage. A value of the quaternary column vector counter 35 is input to the selection pattern. The value of the quaternary column vector counter 35 is sequentially counted up from 0 to 3 in synchronization with the rising edge of the signal DLYCL when the detection signal FIELD is in the active state. In the exemplary embodiment, the selection pattern is repeatedly rotated in the order of the column vectors R0 to R3, and is supplied to the XOR circuit 44.

The adder 46 is provided for eight columns. The adder 46 calculates a sum of exclusive ORs for three rows input from the XOR circuit 44. The XOR circuit 44 and the adder 46 are used to calculate a sum of exclusive ORs of the bits of the selection pattern and the bits of the ON/OFF signals for the corresponding three rows. That is, an MLA calculation is performed. Each of the output signals of the adder 46 is 2-bit data. In the exemplary embodiment, only the high-order 1-bit data, i.e., a total of 8-bit data, is input to the SB latch 48.

The SB latch 48 is also provided for eight columns. The SB latch 48 holds the total of 8-bit data including the high-order 1-bit data of the adder 46 in synchronization with the rising edge of the signal CK when the SEG block 0 is in the active state. The segment blocks 0 to 19 are selected in a time-series manner by the SEG block signals 0 to 19 (not shown), and each of the SB latches 48 for the segment blocks 0 to 19 holds the corresponding total of 8-bit data in a similar manner. The output signals of the SB latch 48 are input to the latch & SEG selector 50.

The latch & SEG selector 50 is also provided for eight columns. The latch & SEG selector 50 holds the 8-bit data input from each of the SB latches 48 for the segment blocks 0 to 19 to the corresponding latch & SEG selector 50, i.e., a total of 160-bit data, at the same time in synchronization with the rising edge of the signal DLYCL, and outputs column-electrode voltages corresponding to the held 160-bit data. In the exemplary embodiment, the latch & SEG selector 50 outputs a column-electrode voltage V0 when the data held in the SB latch 48 is 0, and a column-electrode voltage V1 when the held data is 1.

In the manner described above, the column-electrode voltages are simultaneously output from the latch & SEG selectors 50 for the 20 segment blocks 0 to 19 to the column-electrode voltages SEG 1 to SEG 160, and are simultaneously applied to the 160 column electrodes.

In the conventional MLA drive system, a number of different column-electrode voltages corresponding to (the number of row electrodes to be simultaneously selected+one voltage) are required. In the exemplary embodiment, four column-electrode voltages might be required because three row electrodes are simultaneously selected. However, as described above, the number of column-electrode voltages used is reduced to half to, for instance, two voltages V0 and V1, by using the high-order 1 bit of each of the 2-bit output signals of the adder 46. This technique has been proposed in Japanese Patent No. 3719973 granted to the present inventors.

The exemplary embodiments can be applied not only to a liquid crystal driver in which the number of column-electrode voltages is reduced to half using the technique proposed in Japanese Patent No. 3719973, but also to a liquid crystal driver that conventionally requires (the number of rows to be simultaneously driven+one voltage) different column-electrode voltages.

The operation of the liquid crystal driver 10 will be described.

As described above, in the liquid crystal driver 10, the 120 rows of the liquid crystal panel are divided into 40 common blocks 0 to 39 each having three rows, and the 160 columns are divided into 20 segment blocks 0 to 19 each having eight columns. Three row electrodes are simultaneously selected by the MLA drive system using a cyclic orthogonal matrix with three rows and four columns to control the driving of the liquid crystal panel, and four gradations are displayed per pixel using the FRC gradation system to complete the display of an image of one screen for 12 fields.

In each of the fields, the common-block control circuit 12 sequentially selects the common blocks 0 to 39 according to the value of the CC signal. Each time each of the common blocks 0 to 39 is selected in a time-series manner, the segment-block control circuit 14 sequentially drives the SEG block signals 0 to 19 to the active state according to the value of the SC signal to select the segment blocks 0 to 19 in a time-series manner.

First, the segment block 0 at the common block 0 is selected. At this time, the RAM decoder 38 outputs a memory address corresponding to the segment block 0 at the common block 0. In the segment block 0, gradation data of 48 bits for 24 pixels (i.e., 3 rows×8 columns×2 bits), which corresponds to the memory address of the common block 0, is output from the core memory 40.

The gradation control circuit 18 outputs gradation pattern signals (ON/OFF) corresponding to gradations 1 and 2, for the 24 pixels of the common block 0 specified by the value of the SC signal, using the value of the FC signal according to any of the gradation palettes A, B, and C assigned by the FRC phase table.

Then, the scrambler 42 outputs a 1-bit ON/OFF signal corresponding to 2-bit gradation data of each of 24 pixels on the basis of the gradation data of 48 bits for 24 pixels input from the core memory 40 and the gradation pattern signals of gradations 1 and 2 input from the gradation decoder 36. As described above, the gradation pattern signal of gradation 0 is always “0” (OFF state), and the gradation pattern signal of gradation 3 is always “1” (ON state).

The selection pattern is rotated in the order of the column vectors R0 to R3 each time the detection signal FIELD is driven to the active state, i.e., every field.

Then, the XOR circuit 44 calculates an exclusive OR of each of the bits of the selection patterns and each of the bits of the ON/OFF signals for the corresponding three rows, and the adder 46 calculates a sum of the exclusive OR results. That is, an MLA calculation is performed. Specifically, as described above, an MLA calculation is repeatedly performed in the order of F0*R0→F1*R1→F2*R2→F0*R3→F1*R0→F2*R1→F0*R2→F1*R3→F2*R0→F0*R1→F1*R2→F2*R3.

Since the segment block 0 is selected when the SEG block 0 is driven to the active state, the high-order 1-bit data of each of the 2-bit output signals of the adder 46, that is, a total of 8-bit data for eight columns, is held in the SB latch 48.

The SEG block signals 1 to 19 are also sequentially driven to the active state to select the segment blocks 0 to 19 in a time-series manner, and the operation described above is repeatedly performed. As a result, each of the SB latches 48 for the segment blocks 0 to 19 holds the corresponding 8-bit data.

When the 8-bit data is held in all the SB latches 48 for the segment blocks 0 to 19, the 8-bit data for all the segment blocks 0 to 19 are transferred at the same time from the SB latches 48 to the corresponding latch & SEG selectors 50 and are held therein, and column-electrode voltages corresponding to the total of 160-bit data are output. In the exemplary embodiment, a column-electrode voltage V0 is output when the held data is 0, and a column-electrode voltage V1 is output when the held data is 1.

Accordingly, the column-electrode voltages for SEG 1 to SEG 160 are simultaneously output from the latch & SEG selectors 50 for the 20 segment blocks 0 to 19, and are simultaneously applied to the 160 column electrodes. At the same time, the row-electrode voltage (Vr or −Vr) corresponding to the selection pattern is also applied to the three row electrodes of the common block 0.

The above-described operation is repeatedly performed on the common blocks 0 to 39 constituting one field, and is further repeatedly performed for the 12 fields that constitute one screen to sequentially update the gradation display of one displayed image. In the exemplary system, therefore, the ON/OFF operation of each pixel is not completed every frame of the FRC gradation system but is completed for all frames or fields of the FRC gradation system.

In the exemplary embodiment, a plurality of gradation palettes having different ON and OFF positions are prepared, and are assigned to the pixels of the liquid crystal panel according to a predetermined pattern. In the example shown in Table 9, the gradation palettes A to C are shifted (or rotated) in the row and column directions of the pixels of the liquid crystal panel. The gradation palettes are assigned using the same pattern for 12 fields constituting an image of one screen.

In this way, the gradation palettes A, B, and C having different ON and OFF positions are rotated and assigned to the pixels. Thereby, the ON and OFF positions of the pixels in an intermediate-gradation region can be spatially and temporally dispersed. Therefore, the frame frequency is seemingly higher than that of the ON/OFF data distribution system even though those frame frequencies are the same.

Therefore, the degradation in image quality due to flicker, which is a drawback of the FRC gradation system, can be reduced or suppressed without increasing power consumption, and a high-quality image is displayed with less degradation regardless of the image type. Because flicker is reduced relative to that of the conventional system, the frame frequency can be kept lower than that in the conventional FRC gradation system.

Furthermore, the LCD including the liquid crystal driver 10 of the exemplary embodiment has a small effective voltage difference between pixels for each field, which effectively reduces and/or prevents the instantaneous occurrence of an FRC waving pattern or blinking pattern. Crosstalk is also reduced. Further, it is sufficient that both the frames of the FRC gradation system and the column vectors of a cyclic orthogonal matrix are updated (or rotated) on a field-by-field basis, thus achieving advantages such as a small number of additional circuits and reduced power consumption.

The specific structure of the liquid crystal driver using the simple-matrix liquid crystal driving method according to the exemplary embodiments is not limited to that of the embodiment described above, and various liquid crystal drivers achieving similar functions can be implemented. For example, the size of the liquid crystal panel is not limited to 120 rows by 160 columns, and a liquid crystal panel having any number of rows and columns can be used. A liquid crystal display apparatus according to the exemplary embodiments includes a liquid crystal panel, the liquid crystal driver of the above-described embodiment, and so forth.

Any number of gradation palettes more than one can be used. The arrangement of ON data and OFF data in the gradation palettes is not specifically limited, and a desired number of desired components can be selected as desired from among various combinations of components. The system for gradation control is not limited to the use of only the FRC gradation system, and may be implemented by a combination of the pulse width modulation (PWM) gradation system and the FRC gradation system.

A simple-matrix liquid crystal driving method, a liquid crystal driver, and a liquid crystal display apparatus according to the present invention have been described in detail. However, the present invention is not limited to the above-described exemplary embodiments, and a variety of improvements and modifications may be made without departing from the scope of the present invention.

What is claimed is:

1. A method for driving a simple-matrix liquid crystal panel in which row electrodes of the liquid crystal panel are simultaneously driven in blocks of three row electrodes by a multi-line addressing drive system using an orthogonal matrix and four gradations per pixel of the liquid crystal panel are displayed for every three frames by a frame-rate-control gradation system, comprising:
using a cyclic orthogonal matrix with three rows and four columns as the orthogonal matrix, wherein the three rows correspond to the three row electrodes in at least one of the blocks;
generating three gradation palettes having different phases of ON/OFF data of intermediate gradations;
generating a frame-rate-control phase table for an entire screen of the liquid crystal panel in which the three gradation palettes are distributed so that a sequence direction of the ON/OFF data of the three gradation palettes coincides with a circulation direction of data of the cyclic orthogonal matrix, and assigning a predetermined gradation palette to each of the pixels of the liquid crystal panel;
simultaneously updating frames of the frame-rate-control gradation system and column vectors of the cyclic orthogonal matrix on a field-by-field basis to perform drive control and gradation control of each of the pixels of the liquid crystal panel; and
completing gradation display of each of the pixels of the liquid crystal panel for 12 fields constituting the three frames of the frame-rate-control gradation system.

2. The method according to claim 1, wherein the frame-rate-control phase table is configured such that the three gradation palettes are distributed in both a row direction and a column direction.

3. The method according to claim 1, wherein when the frame-rate-control phase table is generated, gradation palettes are distributed to two sets of three rows to be simultaneously driven so that the gradation palettes are assigned to alternate rows that correspond to two of the blocks of row electrodes, and wherein the sets of the three alternate rows to which the gradation palettes are assigned are simultaneously driven.

4. A method for driving a simple-matrix liquid crystal panel in which row electrodes of the liquid crystal panel are simultaneously driven in blocks of seven row electrodes by a multi-line addressing drive system using an orthogonal matrix and eight gradations per pixel of the liquid crystal panel are displayed for every seven frames by a frame-rate-control gradation system, comprising:
using a cyclic orthogonal matrix with seven rows and eight columns as the orthogonal matrix, wherein the seven rows correspond to the seven row electrodes in at least one of the blocks;
generating seven gradation palettes having different phases of ON/OFF data of intermediate gradations;
generating a frame-rate-control phase table for an entire screen of the liquid crystal panel in which the seven gradation palettes are distributed so that a sequence direction of the ON/OFF data of the seven gradation palettes coincides with a circulation direction of data of the cyclic orthogonal matrix, and assigning a predetermined gradation palette to each of the pixels of the liquid crystal panel;
simultaneously updating frames of the frame-rate-control gradation system and column vectors of the cyclic orthogonal matrix on a field-by-field basis to perform drive control and gradation control of each of the pixels of the liquid crystal panel; and
completing gradation display of each of the pixels of the liquid crystal panel for 56 fields constituting the seven frames of the frame-rate-control gradation system.

5. The method according to claim 4, wherein the frame-rate-control phase table is configured such that the seven gradation palettes are distributed in both a row direction and a column direction.

6. The method according to claim 4, wherein when the frame-rate-control phase table is generated, gradation palettes are distributed to two sets of seven rows to be simultaneously driven so that the gradation palettes are assigned to alternate rows that correspond to two of the blocks of row electrodes, and wherein the sets of the seven alternate rows to which the gradation palettes are assigned are simultaneously driven.

7. A liquid crystal driver using the method according to claim 1, wherein the liquid crystal driver performs drive control and gradation control of the liquid crystal panel.

8. A liquid crystal display apparatus comprising:
the liquid crystal driver according to claim 7; and
the liquid crystal panel,
wherein the liquid crystal driver performs drive control and gradation control of the liquid crystal panel.
